(19) United States
(12) Patent Application Publication
(10) Pub. No.: US 2012/0066304 A1
(43) Pub. Date: Mar. 15, 2012

(54) CONTENT CONFIGURATION FOR DEVICE PLATFORMS

(75) Inventors: Steve Edward Marmon, Mountain View, CA (US); Ralph Zazula, Mountain View, CA (US)

(73) Assignee: Apple Inc., Cupertino, CA (US)

(21) Appl. No.: 13/111,443

(22) Filed: May 19, 2011

Related U.S. Application Data
(63) Continuation-in-part of application No. 12/881,755, filed on Sep. 14, 2010.
(60) Provisional application No. 61/423,544, filed on Dec. 15, 2010.
(60) Provisional application No. 61/470,181, filed on Mar. 31, 2011.

(51) Int. Cl. G06F 15/16

(52) U.S. Cl. 709/204

(57) ABSTRACT

The present technology includes a digital content authoring tool for authoring digital content without the need to understand or access computer code. The present technology further includes creating digital content that is compatible with a diverse population of end user devices without the need for separate versions of the completed content. Instead, the digital authoring tool can manage versions of assets, which individually, can be compatible with different device criteria. Additionally, the present technology contemplates methods of delivering packages of the digital content that are configured to be compatible with the hardware configuration of each requesting device, despite the diverse capabilities of end user devices. Accordingly, the technology described herein provides a simple method for creating and delivering digital content that is configured for presentation on a user's specific device.

### CROSS REFERENCE TO RELATED APPLICATIONS

This application is a continuation-in-part of U.S. patent application Ser. No. 12/881,755, filed on Sep. 14, 2010, entitled CONTENT CONFIGURATION FOR DEVICE PLATFORMS; this application also claims priority from U.S. provisional patent application No. 61/423,544, filed on Dec. 15, 2010, entitled CONTENT CONFIGURATION FOR DEVICE PLATFORMS and U.S. provisional patent application No. 61/470,181, filed on Mar. 31, 2011, entitled INTERACTIVE MENU ELEMENTS IN A VIRTUAL THREE-DIMENSIONAL SPACE; all of which are incorporated by reference herein in their entireties for all purposes.

### CROSS-REFERENCE TO COMPUTER PROGRAM LISTING APPENDIX

Three computer program listing appendices are submitted herewith in ASCII format and have the following file attributes: (1) the file named Appendix1.txt was created on May 12, 2011 and has a size of 12,015 bytes; (2) the file named Appendix2.txt was created on May 12, 2011 and has a size of 34,825 bytes; and (3) the file named Appendix3.txt was created on May 12, 2011 and has a size of 13,910 bytes. All three of which are incorporated herein by reference. The programs contained in these appendices are written in Java and are compatible with any computer or mobile device which is capable of running Microsoft Internet Explorer version 8.0 or later, Mozilla Firefox version 3.0 or later, or Apple Safari version 4 or later.

### COPYRIGHT NOTICE

A portion of the disclosure of this patent document contains material which is subject to copyright protection. The copyright owner has no objection to the facsimile reproduction by anyone of the patent document or the patent disclosure, as it appears in the patent and trademark office patent files or records, but otherwise reserves all copyright rights whatsoever.

### BACKGROUND

1. Technical Field

The present disclosure relates to an electronic content authoring tool and more specifically to an electronic content authoring tool configured to optimize authored content for one more intended devices.

2. Introduction

In many instances, computer-programming languages are a hindrance to electronic content creation and, ultimately, delivery to content consumers. Often content creators and designers simply lack the skill and the knowledge to publish their mental creations to share with the world. To begin to bridge this gap, content creators can use some electronic-content-development tools which allow content creators to interact with a graphical user interface to design the content while an electronic-content-development tool puts the computer-programming code in place to represent the electronic content on a user's computer.

One type of such tool is a web page development tool, which allows a user to create webpages with basic features by designing the webpage graphically within the electronic-content-development tool. However, in most instances, such tools can only assist users with basic features. Users wanting customized elements must still have knowledge of one or more computer-programming languages. For example, while some web-content development tools can assist with the creation of basic hyper-text markup language (html) content, these tools have even more limited capabilities to edit cascading style sheet (css) elements. Often variables within the css code must be adjusted directly in the code. Such adjustments require knowledge of computer-programming languages, which again, many content creators lack.

Another challenge in the creation and delivery of electronic content is that the capabilities of user terminals for receiving and displaying electronic content vary greatly. Even if a content creator successfully creates his electronic content, it is unlikely that the content is optimally configured for each device on which the user will view the content. Originally, digital content was created without having to account for device capabilities. The digital content was going to be viewed on a computer or television having a display of at least a certain size, with at least a certain resolution, if not multiple resolutions. Accordingly, it was possible to generate only one version of the electronic content and that version could be expected to be presented properly by the user's device. However, more recently, smaller displays with fixed resolutions, paltry computing resources, inferior browser technologies, and inconsistent network connectivity such as associated with handheld communication devices have made it so that electronic content isn't always adequately displayed on every device for which a user is expected to view it.

Due to such diverse devices having such diverse capabilities, content must now be created not only once, but often several times so that it can be configured for multiple device types. This development has introduced a new barrier to content creation and delivery. To reduce this barrier, an early technology could create mobile versions of web content by converting a web page intended for viewing on a desktop computer or laptop. Such technology is not suitable for most purposes, because the content creator does not get to see the finished product before it is severed to the mobile device. Another problem is that such technology uses a lowest-common denominator approach, wherein the content is converted so that it can be displayed on any mobile device, despite the fact that many mobile devices can display greatly enhanced content.

Accordingly, the existing solutions are not adequate to eliminate barriers between content creators and the presentation of high quality electronic content on a variety of platforms.

### SUMMARY

Additional features and advantages of the disclosure will be set forth in the description which follows, and in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present technology provides a digital content authoring tool for amateur and professional content developers alike, without the need to understand or access any computer code, though that option is available to users skilled in the programming arts. In addition to the ability to create high quality digital content, the authoring tool is further equipped with the ability to manage digital assets and configure them for distribution and viewing on a variety of electronic devices—many of which have diverse hardware capabilities. Accordingly, the presently described technology eliminates many barriers to creating and publishing deliverable electronic content.

The authoring tool receives a collection of assets and other files collectively making up deliverable electronic content. In some instances, the authoring tool provides one or more templates, such as a menu navigation template or one of the pre-defined objects referenced above, as starting points for the creation of electronic content. The templates can include containers configured to receive digital assets so a content creator can modify the templates according to his or her vision. In some embodiments, the authoring tool is configured to receive digital assets by importing those assets into the authoring tools asset library. The assets can be imported through a menu interface or through drag and drop functionality. The assets then may be added to the templates by, for example, dragging the asset onto the desired container on the template or through a menu interface.

In addition to assets, the finished content is created by modifying formatting elements using a widget such as an inspector for modifying Cascading Style Sheet variables and by applying JavaScript elements from a JavaScript library. Custom styles and JavaScript elements can also be created as plug-ins to create highly customized content.

The present technology utilizes an additional layer of abstraction between the graphical elements represented in the graphical user interface and the code that represents them. Specifically, the present technology utilizes a common scheme to identify variables and to modify those variables using a widget such as a graphical user interface inspector rather than having to modify the variables in the underlying code. The present technology additionally utilizes a JavaScript library to implement additional code to perform a variety of features including alternate implementations of an object, event handling behaviors, error handling, etc.

Whether a particular code element (written in HMTL, CSS, JavaScript, etc.) is provided by way of a template within the authoring tool, or is created by the user, the code element conforms to the common scheme within the layer of abstraction. Variable elements can be defined, and identified, either within the code or within a related properties file, which associates the defined variable elements with adjustable user interface elements in an inspector. The type of user interface element, the range of possible values for the defined variable are all identified in the code or properties file accompanying the basic code element. Because of the common scheme, even a custom created element can be adjusted within the user interface because the custom created element also identifies variable elements, the accepted values for the variable elements, and the type of inspector needed to appropriately adjust the variable elements. Further because the extra code defining the ability to modify the variable elements conforms to the common scheme it can easily be identified and removed once it is no longer needed, i.e., after the content is created and ready for upload to a server.

The authoring tool also leverages a JavaScript library running in the background to enhance the code elements, by writing additional code that facilitates the smooth functioning of the objects defined by the code elements, even when those objects are implemented on diverse devices. The JavaScript library instantiates the objects specified by the user using the authoring tool and generates additional code (HTML/CSS/JavaScript) as needed to display the content. This allows the authoring tool to substitute alternate implementations for various situations, such as diverse devices, as needed.

As an example of the functioning of this abstraction layer, a code for a “Button” defines its user-modifiable parameters (size, position, color, etc.), and required parameters that may be managed by the system without the users knowledge (event handling behaviors, error handling, etc.). The application outputs the information required to construct a “Button”, and simulates this in the application user-interface, possibly using the same implementation that will be used at runtime, but there is a possibility that a modified or entirely different implementation will be provided at runtime.

Because the code defining the object meets the common scheme defining user-modifiable objects in the authoring tool, this extra functionality required only at authoring time (user input validation, special handling of authoring environment preview functionality, etc.) is removed when the content is published.

Additionally, the JavaScript library can determine, that graphics processor dependent functionality such as shadows, gradients, reflections are not supported on the device and should be ignored and replaced with less processor intensive UI even if the author specified them.

The finished product can be validated for distribution to one or more known devices that are intended targets for the deliverable content. The publishing tool can determine device criteria associated with each of the devices that are intended to receive the deliverable content from a library of devices or known device criteria. In some embodiments, the device criteria comprises hardware capabilities of a given device. For example, the device criteria can include screen size, resolution, memory, general processing capabilities, graphics processing, etc.

The validation comprising analyzing assets and files for compatibility with the device criteria and, in some instances, expected network connection states, including connection types such as cellular connections or wi-fi, connection reliability, and measured connection speeds.

Once validated, the deliverable content that is compatible with the device criteria can be compiled into a content package for delivery to content consumers using one of the known devices.

In some embodiments, a content delivery server can store a collection of versions of assets, each being compatible with different device or network criteria. In such embodiments, the content delivery server can be configured to select an appropriate version of the asset based on run-time network conditions and the device criteria associated with the device that is requesting the content from the content delivery server.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure, and are not therefore to be considered to be limiting of its scope, the principles herein are described and explained with additional specificity and detail through the use of the accompanying drawings in which:

FIG. 1 illustrates an exemplary graphical-application-flow template screen within a graphical user interface of the authoring tool;

FIG. 2A illustrates the exemplary graphical-application-flow template screen as an initial content creation screen;

FIG. 2B illustrates the result of the action illustrated in FIG. 2A;

FIG. 3 illustrates an exemplary action adding additional pages to the template;

FIG. 4A illustrates exemplary modifications made to the content of a single page;

FIG. 4B illustrates an updated Pre-roll page based on the action illustrated in FIG. 4A;

FIG. 5A illustrates an exemplary action inserting multiple images into a page;

FIG. 5B illustrates the page from FIG. 5A updated with one of the images inserted;

FIG. 5C illustrates the page from FIG. 5A updated with one of the images inserted;

FIG. 6 illustrates an updated graphical-application-flow template screen view;

FIG. 7A illustrates exemplary adjustments to CSS elements using a widget/inspector;

FIG. 7B illustrates the result of the action illustrated in FIG. 7A;

FIG. 8 illustrates an exemplary CSS inspector;

FIG. 9A illustrates an exemplary menu of JavaScript elements;

FIG. 9B illustrates an exemplary menu of JavaScript elements;

FIG. 10A illustrates an exemplary JavaScript elements menu having buttons for editing selected code;

FIG. 10B illustrates editing a JavaScript element;

FIG. 10C illustrates adding a new JavaScript element;

FIG. 11 illustrates a completed application in the graphical site map view;

FIG. 12 illustrates an exemplary asset validation process;

FIG. 13 illustrates an exemplary method of packing the application for upload to a content delivery server;

FIG. 14 illustrates an example system embodiment;

FIG. 15A illustrates an exemplary perspective wall JavaScript element;

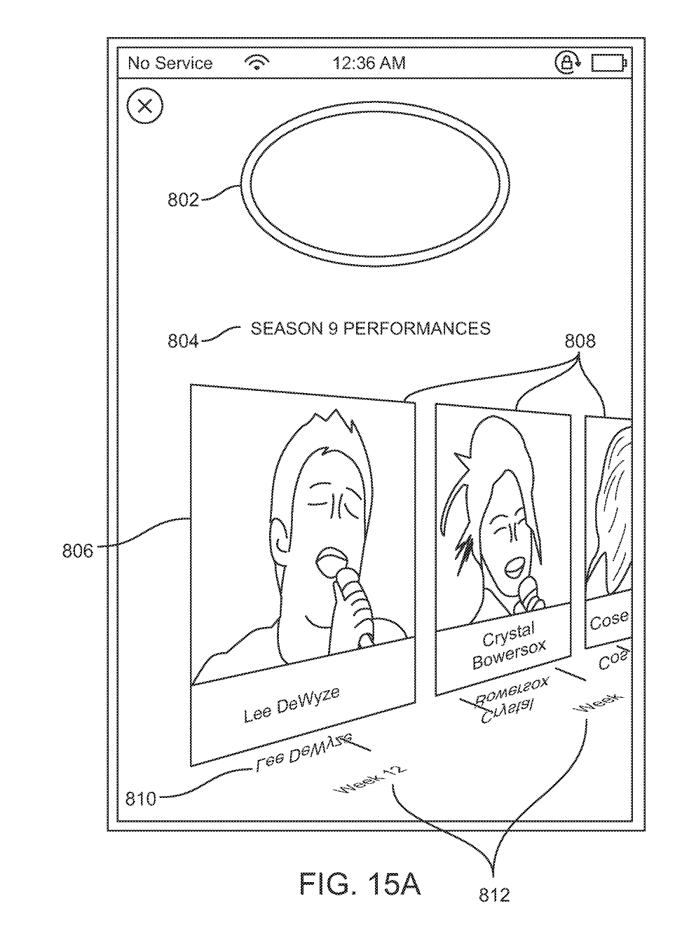

FIG. 15B illustrates an exemplary selection action;

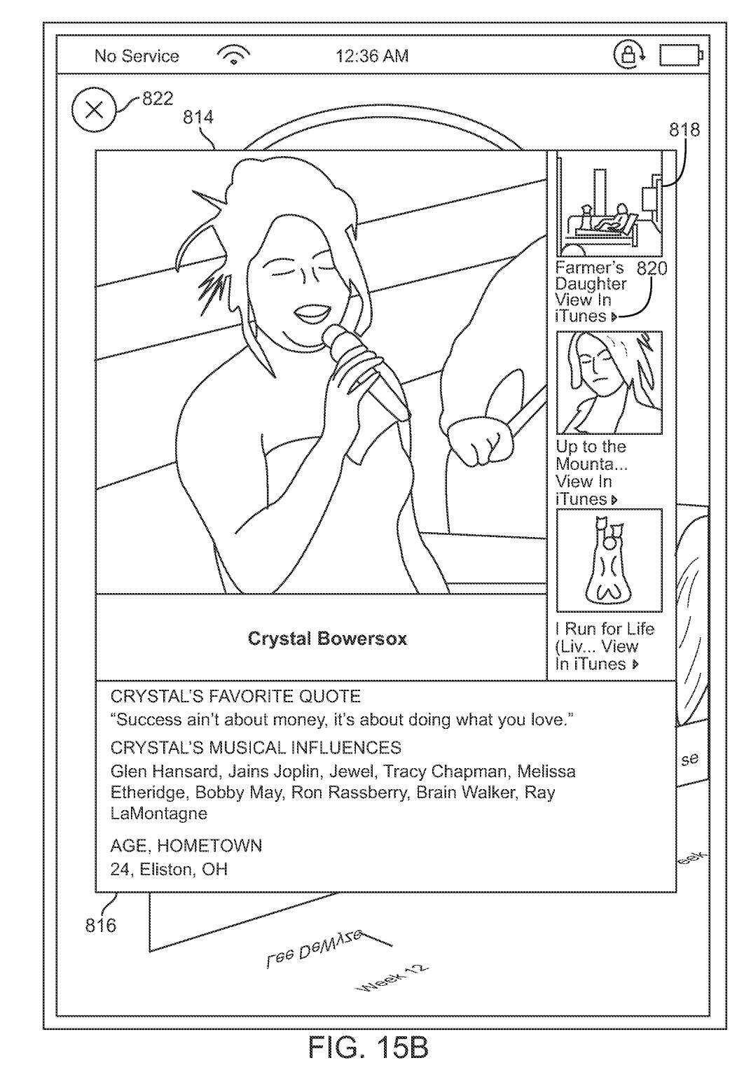

FIG. 16 illustrates an exemplary pinwheel menu JavaScript element;

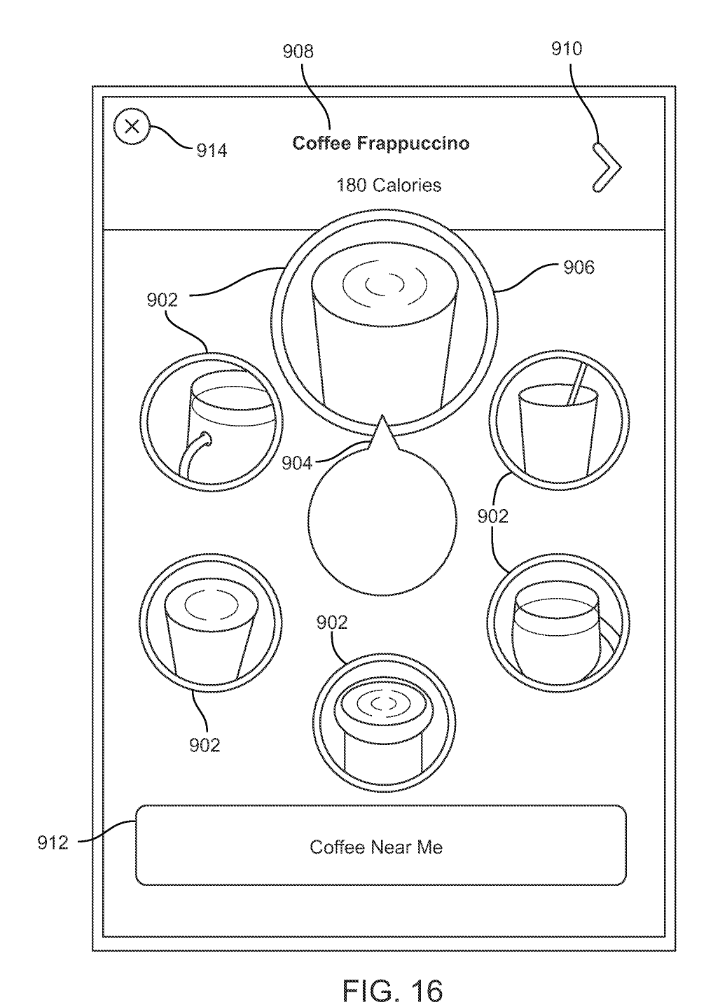

FIG. 17A illustrates an exemplary bare N×M gallery JavaScript element;

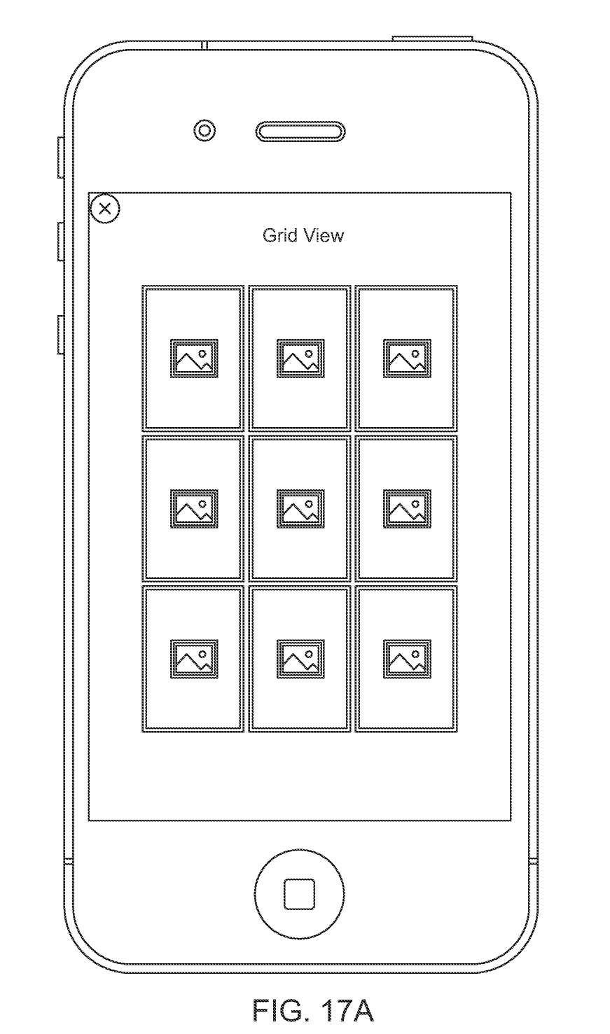

FIG. 17B displays an exemplary 3×3 gallery JavaScript element;

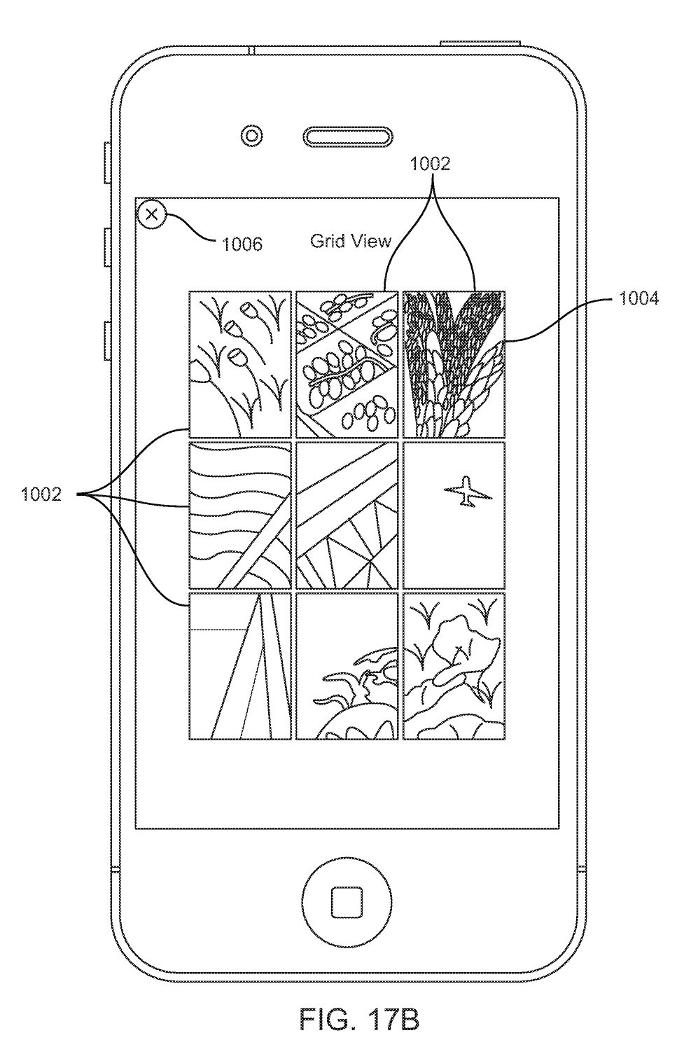

FIG. 17C illustrates an exemplary transition effect;

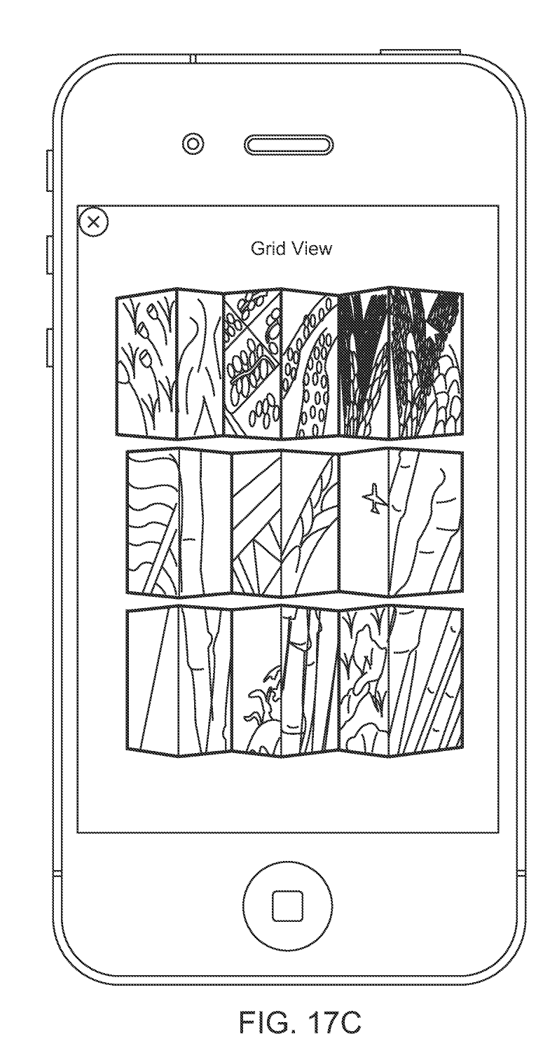

FIG. 17D illustrates an exemplary transition effect;

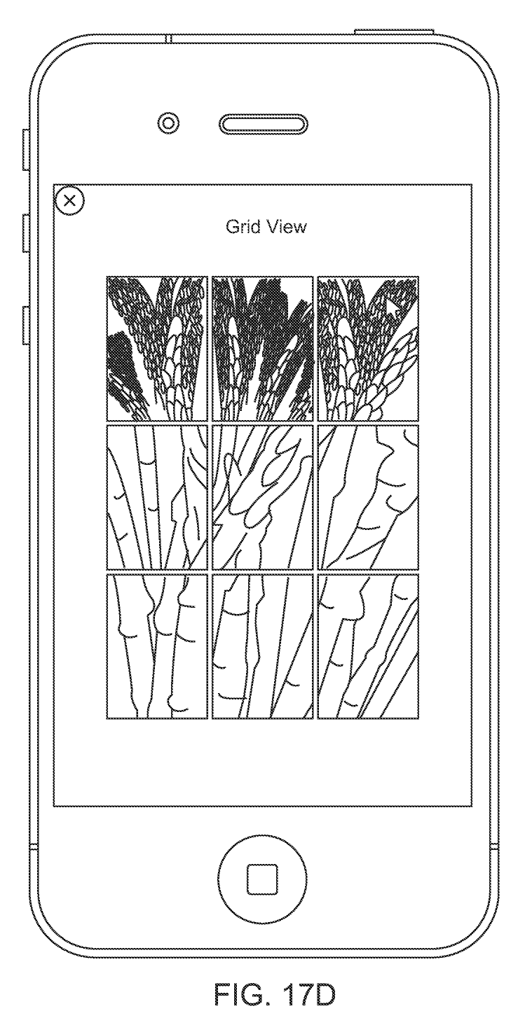

FIG. 17E illustrates an exemplary completed transition effect;

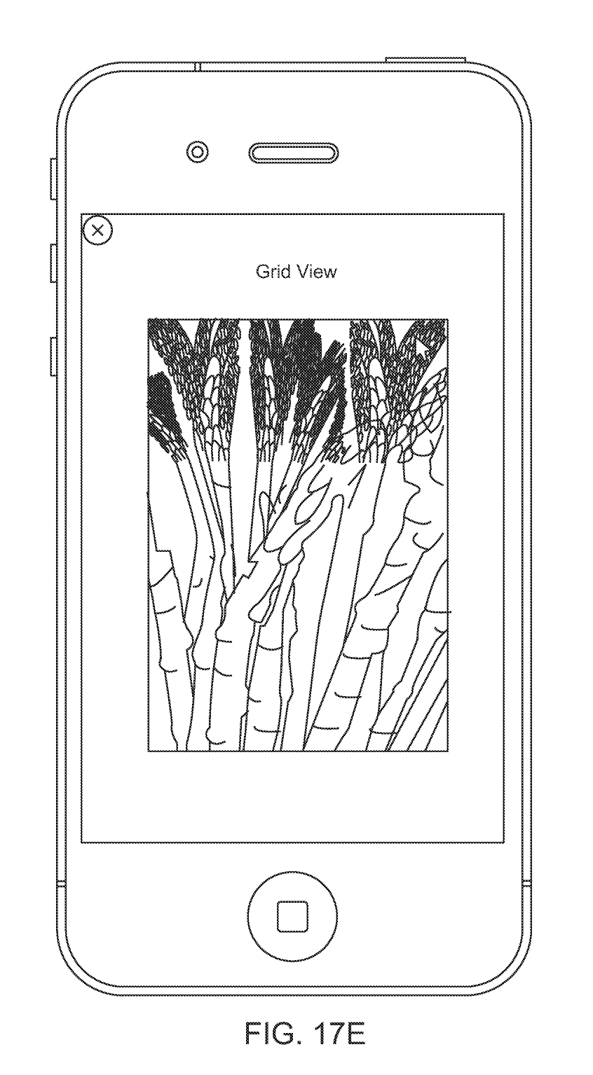

FIG. 17F illustrates an exemplary interface for adjusting JavaScript variables; and

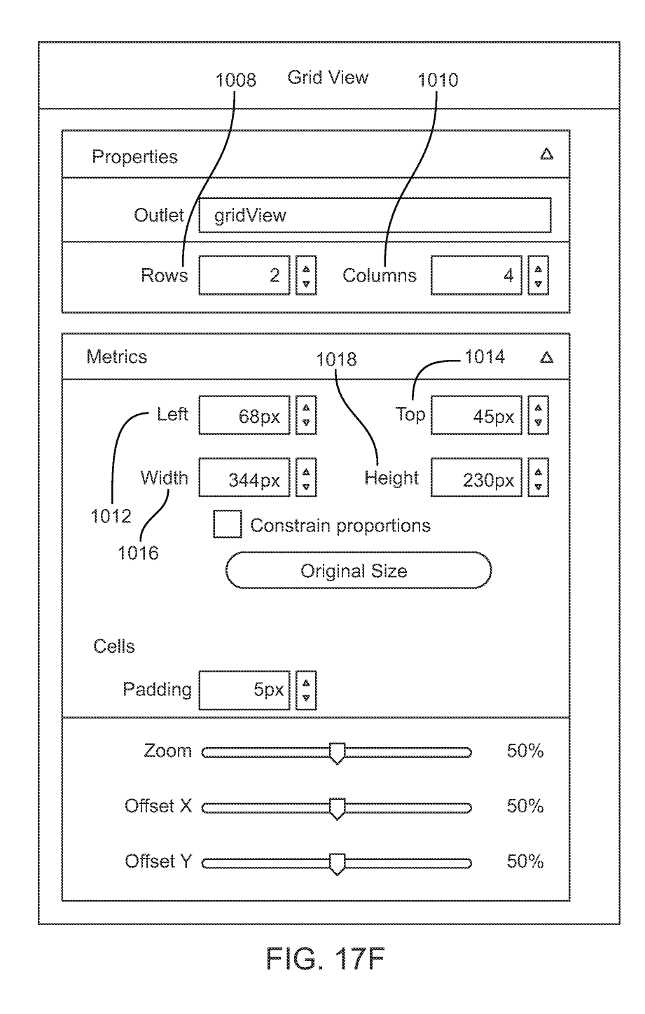

FIG. 17G illustrates an exemplary gallery having various variables adjusted with an inspector.

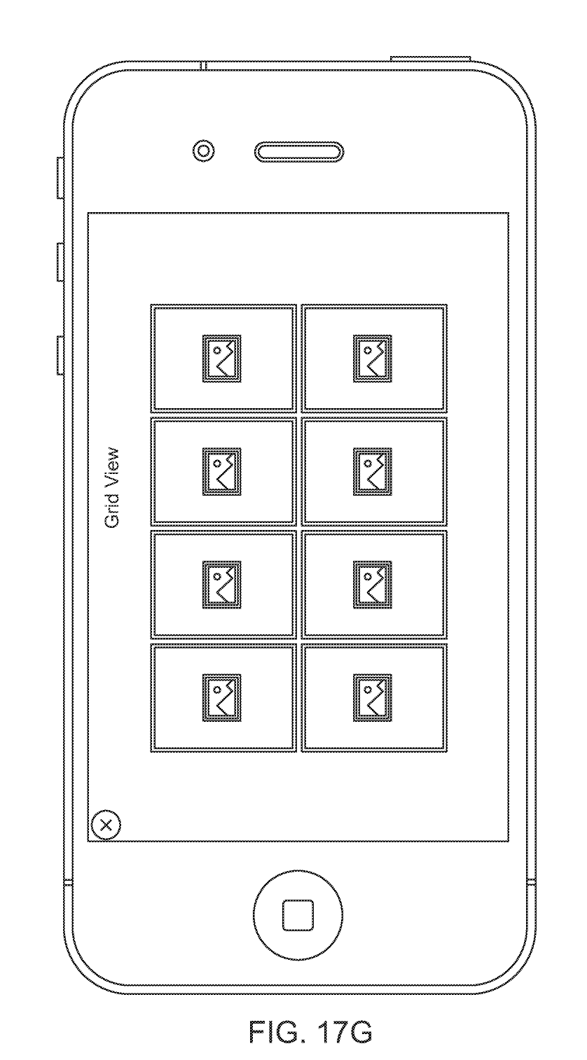

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art to eliminate or reduce barriers between content creators and presenting their content to content-consumers.

In some embodiments, the present technology relates to a computer-implemented application for aiding in the creation of electronic content. In one aspect the present technology aids a content developer in creating a multimedia application or web-based application, though it is not limited to such uses.

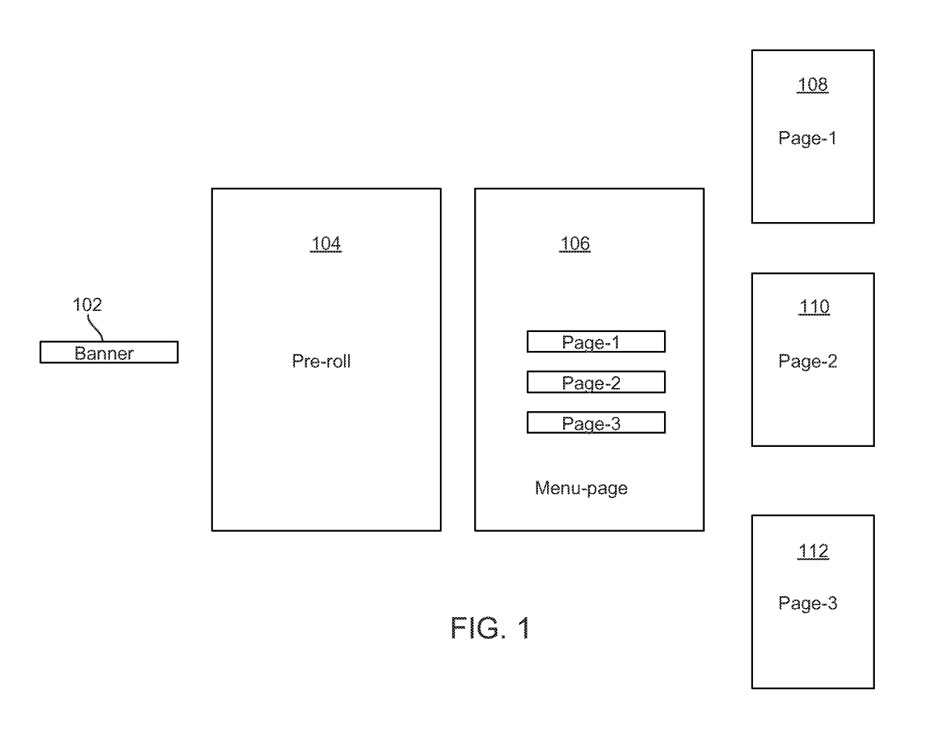

FIG. 1 illustrates a graphical-application-flow template screen within a graphical user interface of the authoring tool. This screen illustrates a general layout of a typical application and is the starting point of the authoring tool. The typical application can progress in layers moving from left to right.

For example, banner 102 is often the first part of the application presented to content consumer. In some embodiments, the banner can be an image, video, or text that is presented to a content consumer, sometimes within other content. In such instances, the banner is similar to a banner advertisements commonly encountered on the Internet. In some embodiments, the banner is more akin to an icon on a desktop.

In either analogous situation (a banner advertisement or an icon) a content consumer can interact with the banner 102, often in the form of a click or selection action, which progresses the content into its next screen, the pre-roll 104. The pre-roll screen can be as simple as an icon indicating that the full content is loading, or more involved, such as a progress base, title page, or a movie.

After the pre-roll screen has completed, the user is presented with the menu-page 106. The menu page is analogous to home page on an Internet website, or a title menu commonly encountered in a movie on a digital video disk (DVD). The menu-page 106, links to all or most other subsequent pages of the application. As an example, menu-page 106 links to subsequent pages, Page-1 108, Page-2 110, and Page-3 112, which each contain their own content.

While the template illustrated in FIG. 1 is one example of a potential application template, other templates may be available. In some embodiments the templates can be modifiable. For example, one or more additional screens can be added, deleted, repeated, or otherwise modified as seen fit by the content-creator. However, in some embodiments the template is not modifiable by the user. In some embodiments portions of the template are modifiable while others are not. A modifiable template, for example, may include containers configured to accept assets. For example, the banner and menu pages can be required, and/or the flow of certain pages (banner->preroll->menu) is fixed.

A content-creator can add assets to the pages to easily fill out their application. An asset can be any file containing digital content. The content-creator can import the content-creator's assets into the authoring tool by dragging a collection of assets or a directory containing assets into an assets menu (illustrated in subsequent figures), or can import the assets using menu options, or by any other known mechanism. The asset may then be added to the desired container in the template. This may be accomplished in a number of ways, including dragging the asset onto the container or through a menu interface.

In some instances, one or more assets can be interrelated. In some embodiments, the content creation application can also detect those relationships that can be useful later. For example, if a movie is imported at the same time as its poster frame, the authoring tool can associate the poster frame with the movie. The simplest example of how this can be executed is anytime a movie file is imported with a single image, the authoring tool can assume the that the image is the movie poster frame and create that association in the meta data of those respective files.

The poster frame can be an image in JPEG format with dimensions that match those of the video player that will be used to play the movie. It is also desirable to name the image file according to a pre-defined naming convention so that the authoring tool can identify and associate the poster with the appropriate video. This is especially useful when more than one other asset is imported along with the poster frame.

In some instances, when a specific asset is imported, the authoring tool can recognize that another related asset is needed and automatically create the asset. Using a movie file as an example, if the movie file is imported without a poster frame, the authoring tool can search the movie file for its poster frame and extract the image. If the authoring tool cannot find the poster frame within the video file, it can automatically use the first frame, or first non-blank frame, as the poster frame. In another example, the authoring tool can require multiple different encoding ratios or bitstreams for a movie depending on the device that the content is intended to be viewed on and its current connection speed. In such instances, the authoring tool can compress the movie file according to the specifications needed for that particular device, anticipated network bandwidth, or several devices and network combinations. Analogous examples can also be made with music bitrates, or aspect ratios and bits-per-pixel (BPP) for images.

As will be addressed in the following figures, assets can be added to the page templates by dragging the asset from an asset menu and dropped onto a container on the page templates, by using an insert asset menu option, or by any other known mechanism for inserting an object. In some embodiments, containers on different pages, or on certain locations on a page, can only accept certain types of assets. While in some embodiments, containers on different pages or locations on a page can accept any type of asset, and these pages will configure themselves to be compatible with an inserted asset. Containers, for example, can be a portion of a webpage or the entire background.

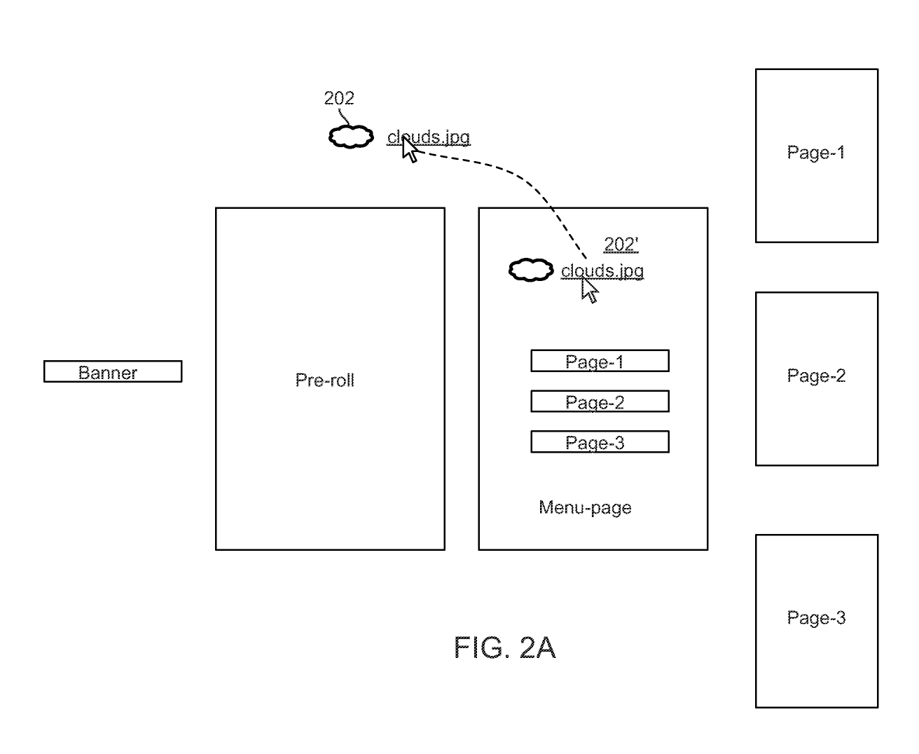

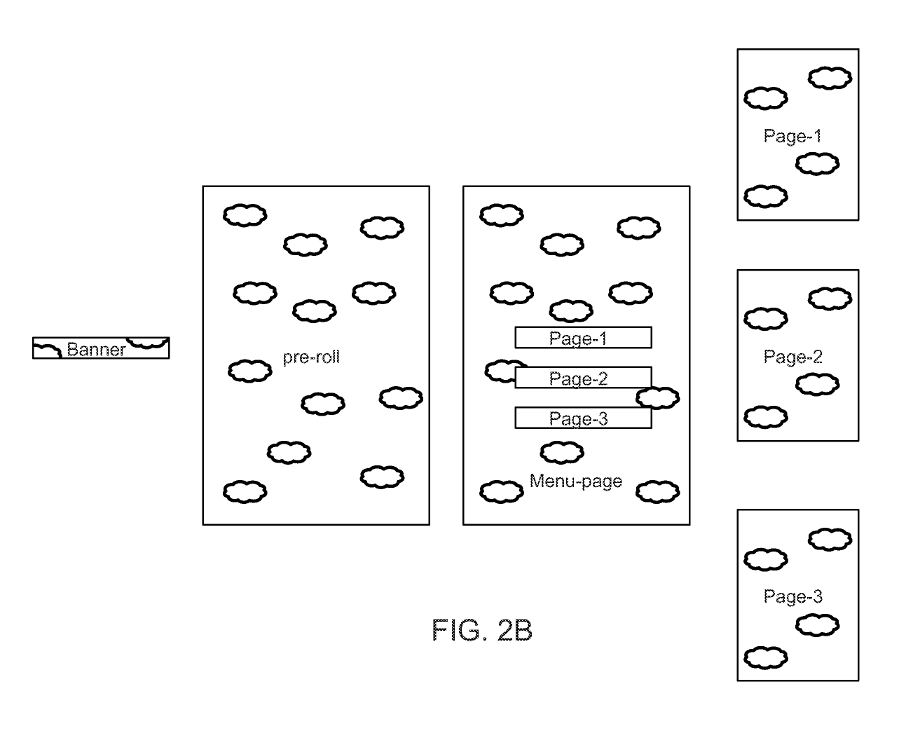

As addressed above, in addition to being a graphical-application-flow template screen, the screen illustrated in FIG. 1 is also able to receive content. FIG. 2A illustrates the graphical-application-flow template screen as an initial content creation screen. In FIG. 2A, the content-creator has selected an asset, a clouds.jpg image 202 and drags the image onto the menu page as indicated by 202′. FIG. 2B illustrates the result of the action illustrated in FIG. 2A, wherein the clouds.jpg image has been applied to the entire template. Each page in the graphical-application-flow template now has the clouds.jpg image as a background image.

When a modification is made to one screen in this a graphical-application-flow template screen view, showing each of the screens within the application, the same modification is made to each of the other screens, as appropriate. As in the example illustrated in FIG. 2A and FIG. 2B, since the background of the Menu-page was modified, the background of all of the screens within the application was also modified. Other modifications in one screen that can be translated to the other screens include, but are not limited to, adjustments to fonts and colors, or relationships between Page-1 and the menu item for Page-1. However, not all modifications made in this view make sense to translate to the other screens. A modification to the Pre-roll might not make sense to add to the other pages. For example, adding a video to the pre-roll screen is one such modification that would not be applied to the other screens.

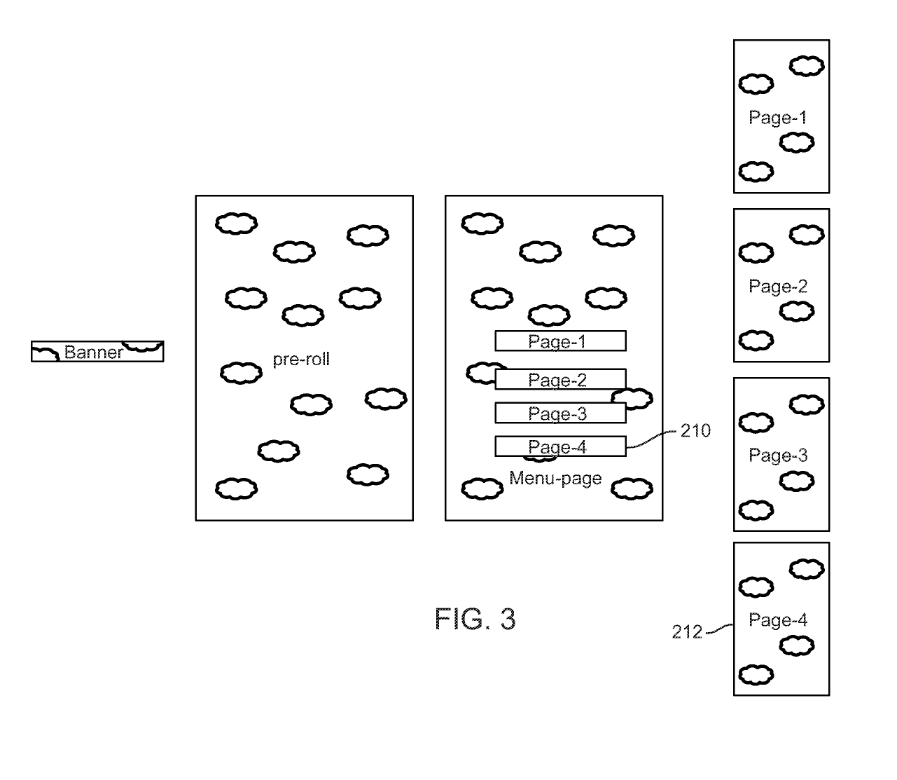

FIG. 3 illustrates that additional pages can be added to the template. When a new page is added, such as Page-4 212, the Menu-page updates to include the page in the menu as illustrated by menu item 210. Additionally, any template-wide characteristic, such as the cloud background, is automatically applied to the new page. Other changes can also be propagated automatically, as is discussed throughout. For example, when a page is renamed the corresponding menu element can also be retitled.

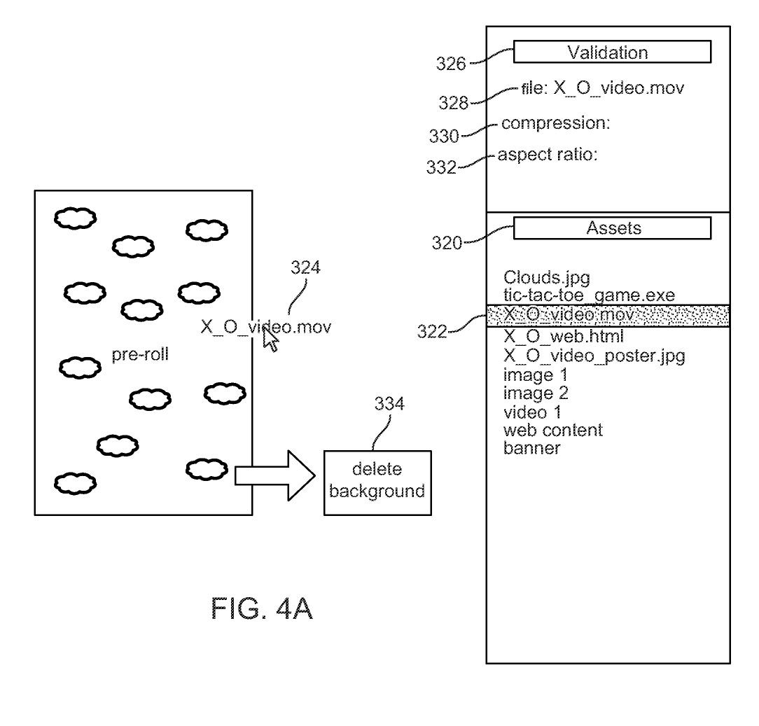

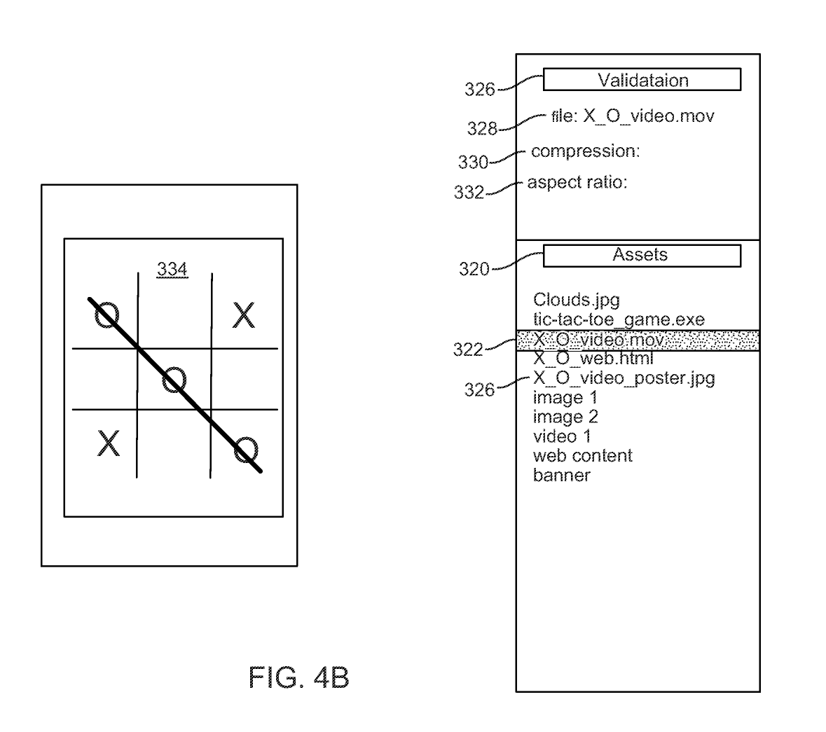

FIG. 4A illustrates modifications made to the content of a single page. 334 illustrates that commonly applied elements can be modified or removed on the individual pages of the application. Specifically 334 illustrates that the cloud background that was automatically applied to the pre-roll page in the graphical-application-flow template screen, can be removed from this page, individually, in this screen specific view.

Also illustrated in FIG. 4A is an “Assets” menu 320. This menu graphically lists each of the assets that are available for inclusion into the program. These assets include text, videos, web content, images, etc. that the user has created and made available to the authoring tool.

Also illustrated is a Validation tool 326 to validate selected assets. In the illustration, X_O_video.mov 322 is selected and the validation tool can illustrate the particular characteristics of the file and whether those characteristics are compatible with one or more device types for which the content is intended to be displayed. Validation will be discussed in more detail below.

FIG. 4A also illustrates that asset 322 is being dragged on dropped 324 on the Pre-roll screen, thus inserting the asset onto the Pre-roll page.

FIG. 4B illustrates the updated Pre-roll page. The cloud background has been deleted and the X_O_video.mov has been inserted on the Pre-roll pages and its poster image (asset 326) is displayed 334.

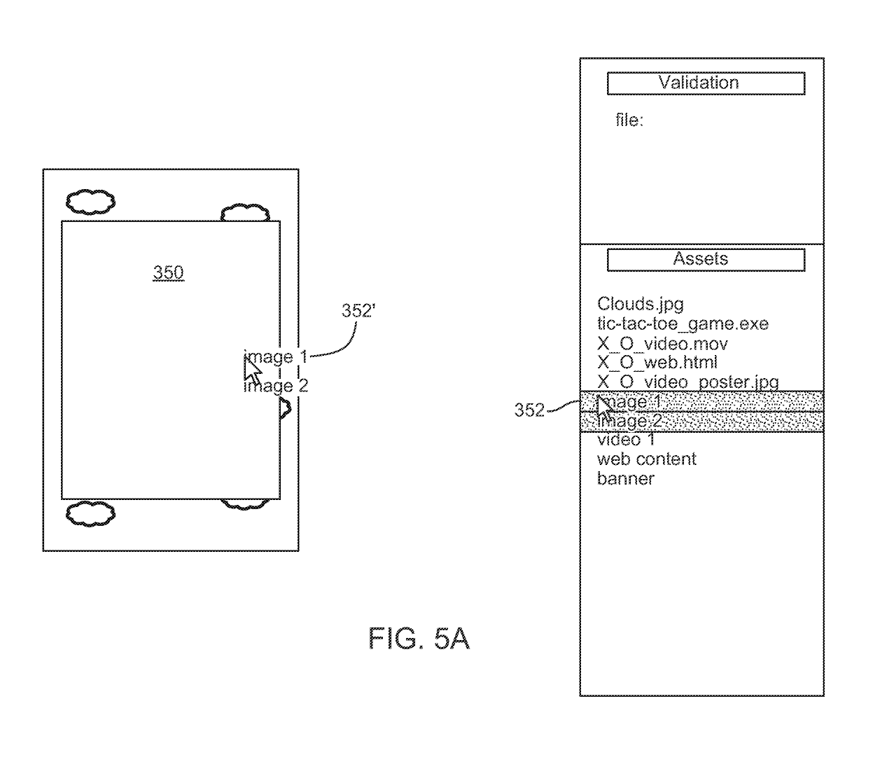

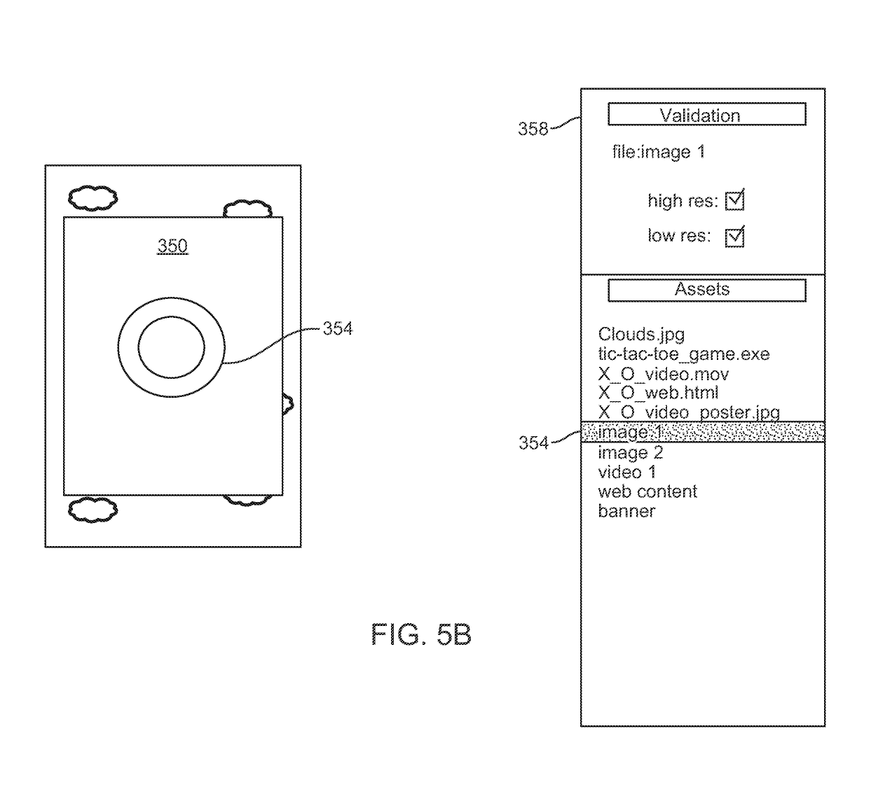

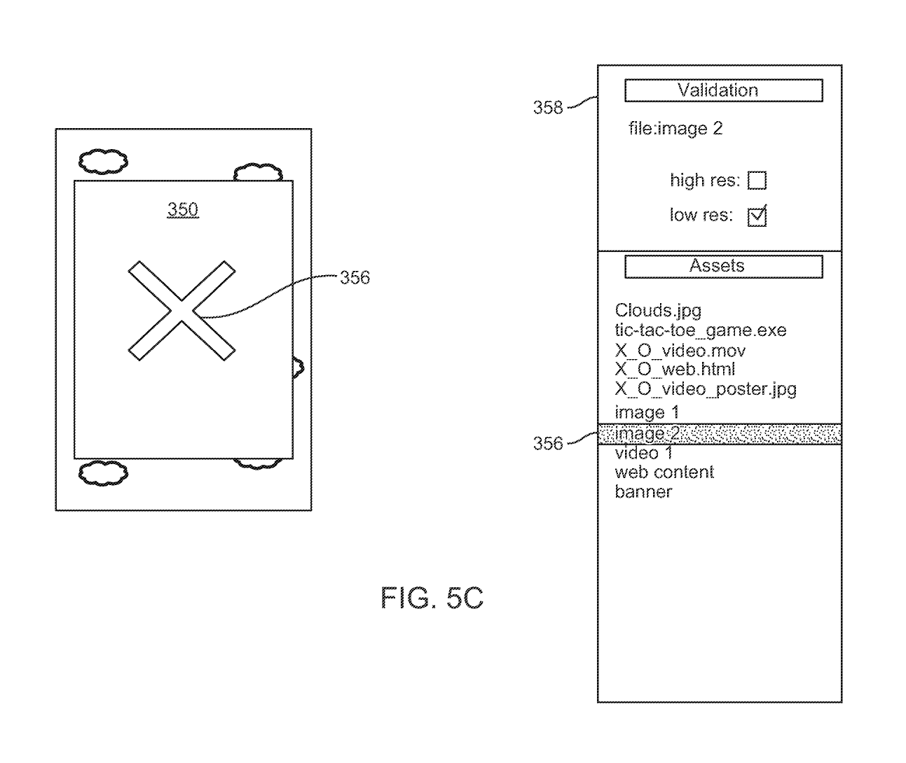

FIG. 5A illustrates inserting multiple images into a page. Specifically Page-1 is shown having an object container, or placeholder 350. A user has selected two images 352, image 1 and image 2 and has dragged and dropped the images 352′ into placeholder 350.

FIG. 5B illustrates the updated page having both images of the images inserted, but only displaying the first image. Specifically, container 530 is shown with image 354 displayed within it. Additionally, the validation tool 358 is shown validating that the image 354 is available in the required resolutions (high and low). When image 1 was imported, the user imported two images—the high-resolution image and the low-resolution image. However, for simplicity of use, the authoring tool recognizes that the images are two different versions of the same asset and displays a common asset in the asset library. This allows the user to manipulate a single object (e.g., dragging to the canvas) to make the assignment and the authoring tool works behind the scenes to grab the appropriate version based on the current display mode. In some embodiments, the assets conform to a naming convention to allow the authoring tool to associated two different versions of the assets. For example, a user can create image_{—}1@2×.jpg and image_{—}1.jpg files. When imported, we associate these two as the 2× and 1× versions, respectively, for an asset named image_{—}1.jpg. In the user interface the authoring tool would only display one entry, but flags it to indicate it is a multi-resolution asset, for example: image_{—}1.jpg [1×] [2×]. The availability of both required assets is indicated in the real time validation tool 358.

FIG. 5C illustrates the updated page having both of the images inserted, but only displaying the second image. Specifically, container 350 is illustrated with image 356 displayed within it. In this instance, the content creator has chosen to navigate to the second image within the design application. It can be especially useful to show the exact assets and user interface that the end user device will see at run time so that the content designer can adjust the content as needed without having to switch from a design application to a test application. Additionally, validation tool 358 indicates that image 2 356 is only available in low resolution and that a high resolution image is still needed. As can be inferred from the discussion above, Image_{—}2 was imported without a corresponding high-resolution version. The real-time validation tool 358 can inform the content developer that the high-resolution asset is needed.

While in some embodiments it is possible for the authoring program to make missing assets from available counterparts, it is not desirable to create a higher resolution image from a lower resolution image. However, the authoring tool may be able to create a lower resolution from a properly sized higher resolution image. In either case, the application will indicate which assets were provided by the user and which were automatically generated, so that the user can review these proposed auto-generated assets and decide if he/she wants to use them or provide his/her own.

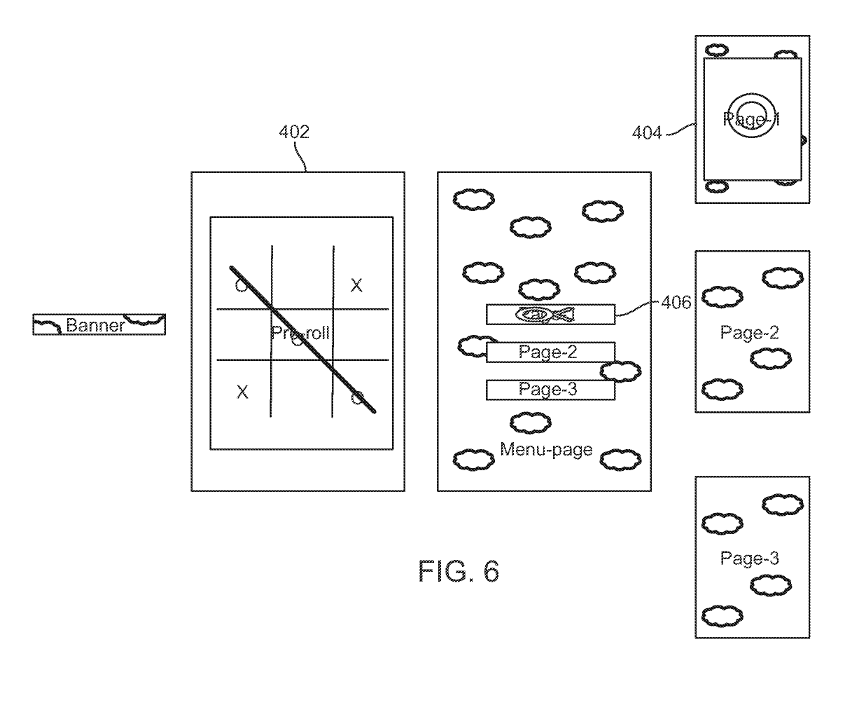

FIG. 6 illustrates an updated graphical-application-flow template screen view. The pre-roll screen 402 is illustrated with the update made to that page in FIG. 4A. Notably, the background has been deleted and a movie has been inserted. The movies poster frame is illustrated. Additionally, Page-1 404 is illustrated with one of the images inserted into that page in FIG. 5A. The menu page has also updated to match the changes made to Page-1. Link 406 now contains an icon made from a blend of the images inserted in Page-1. The link image could have been an asset that was associated with the figures, an asset that was separately inserted, or, in some embodiments, it can be automatically generated.

As addressed above, simply helping content developers get their content into an application is just one step in the process. An authoring tool needs to also allow content creators to adjust their creations and the functionality of the application within the user interface of the authoring tool.

This principle of the present technology can be understood by exploring a web-based application or a collection of web-browser-compatible content resembling the application. Web-browser-compatible content often has several different components of code. For example, Hyper-text-markup language code (HTML) can define the basic format and content, JavaScript can define the movement of objects defined by the HMTL code, and cascade style sheet (CSS) elements can adjust the format or style of the formatting elements defined in the HTML code. (It is understood that other code types and objects are also web-browser-compatible content. The present technology should not be considered limited to the code languages described herein.)

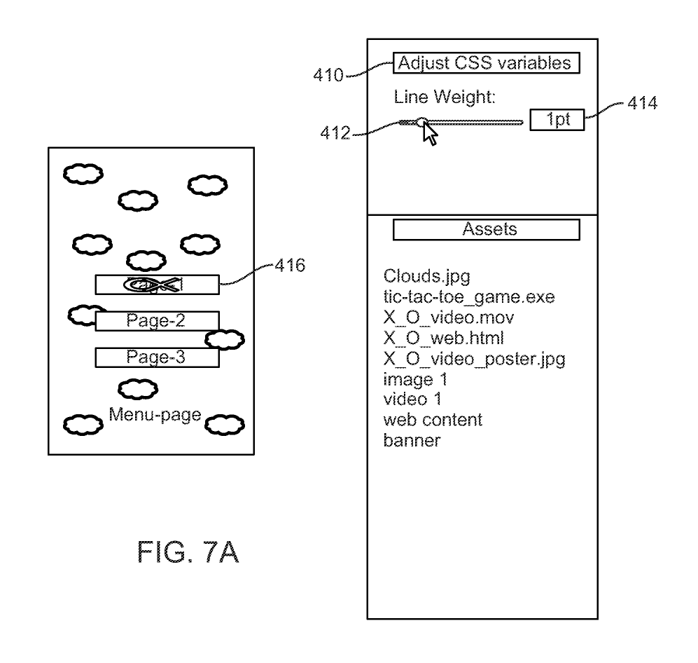

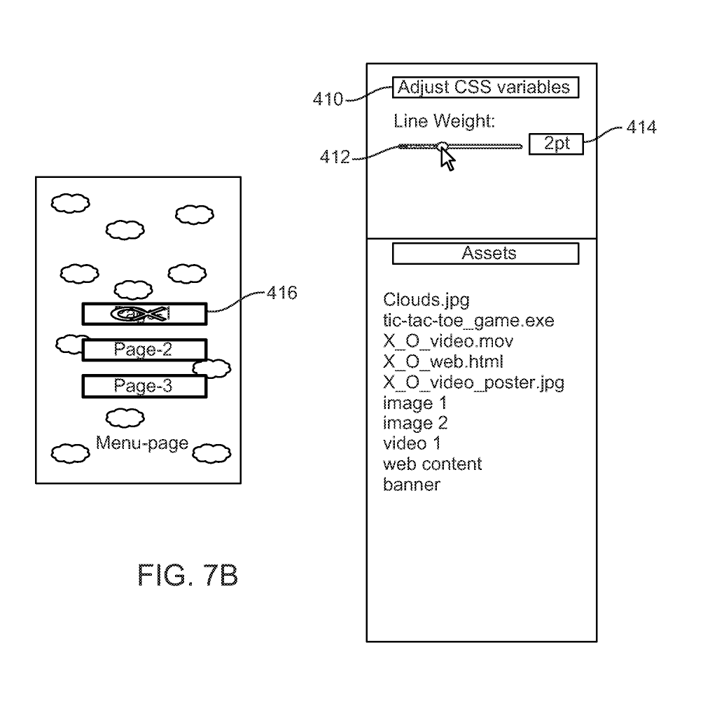

In such an application using HTML code, JavaScript and CSS, it is not sufficient to merely allow a content creator to enter content in HTML. The content creator needs to be able to make refined adjustments to make high quality content. As illustrated in FIG. 7A and FIG. 7B such adjustments can be made using a widget to adjust CSS elements. A CSS widget or inspector 410 is displayed for adjusting a line weight by a slider 412 user interface element or by entering a value in a text box 414. In the illustrated example, the content creator is adjusting the line weight used to display the box 416. FIG. 7B illustrates that the line weight has been adjusted by moving the slider to a 2 pt line weight. The slider and text box have adjusted corresponding to this change.

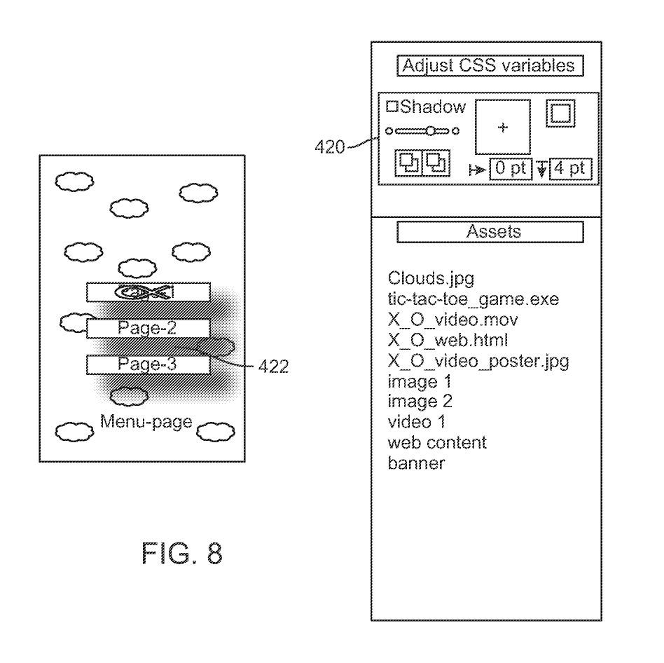

FIG. 8 illustrates another CSS inspector. Specifically, a shadow inspector 420 can be manipulated to adjust the direction, weight, offset and other attributes of a shadow, such as shadow 422.

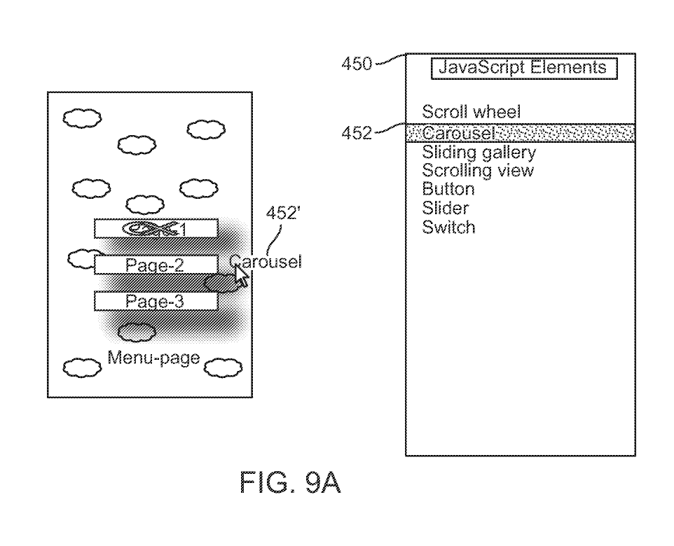

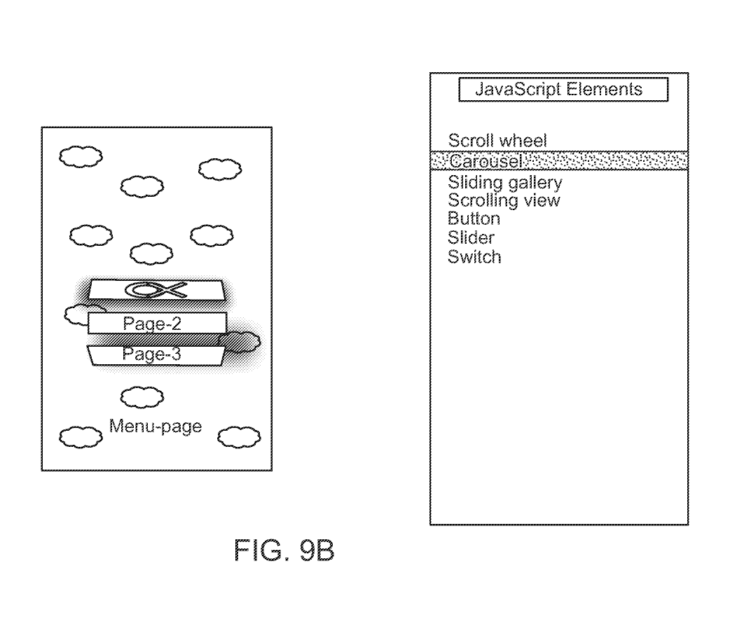

FIG. 9A and FIG. 9B illustrates a menu of JavaScript elements. Again, it is desirable to allow content-creators to introduce and adjust their content as much as possible within the user interface. As such, the present technology makes use of a JavaScript library of JavaScript elements such as those presented in the JavaScript menu 450. The JavaScript library can include primitive elements such as buttons, sliders, and switches that are used standalone; and more complex “composite” elements such as carousels, scroll views, and lists that have multiple “cells” that may contain primitives and other composite elements. It should be appreciated the other common JavaScript elements not shown here can also be included in the JavaScript library.

As illustrated, a user has selected the Carousel element 452 and dragged and dropped the Carousel element 452′ onto the menu page. Such action transforms the listing of links on the menu page into a rotatable 3-D Carousel as illustrated in FIG. 9B.

In some embodiments, widgets or inspectors can also be provided for adjusting known variables within the JavaScript code. For example, in the case of the rotatable 3-D Carousel, the shape of the menu items, the speed and direction of rotation, spacing, number of containers on the menu can be adjusted using an inspector. Additionally, the number of containers can be increased by just dragging additional assets onto the carousel.

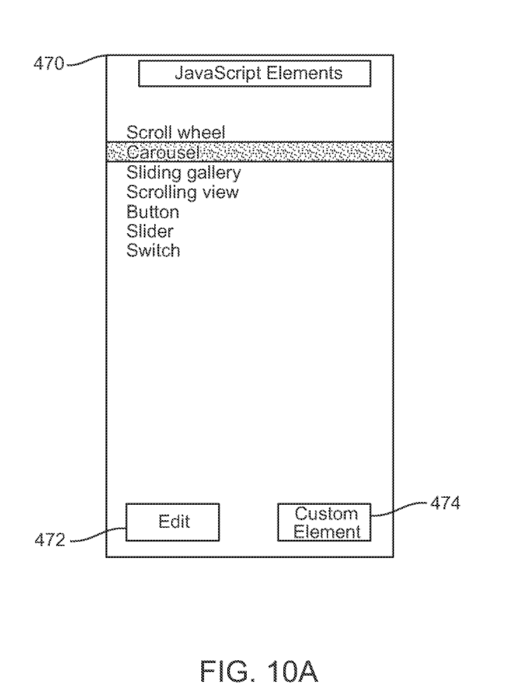

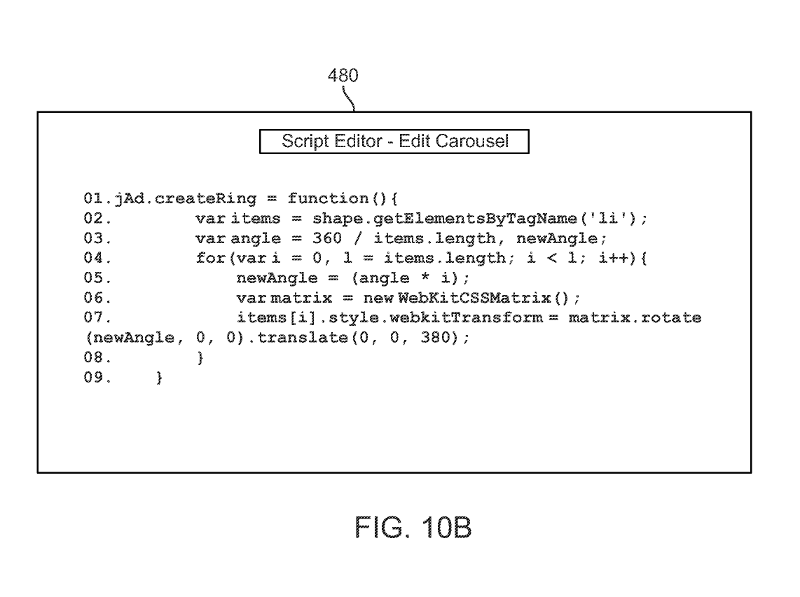

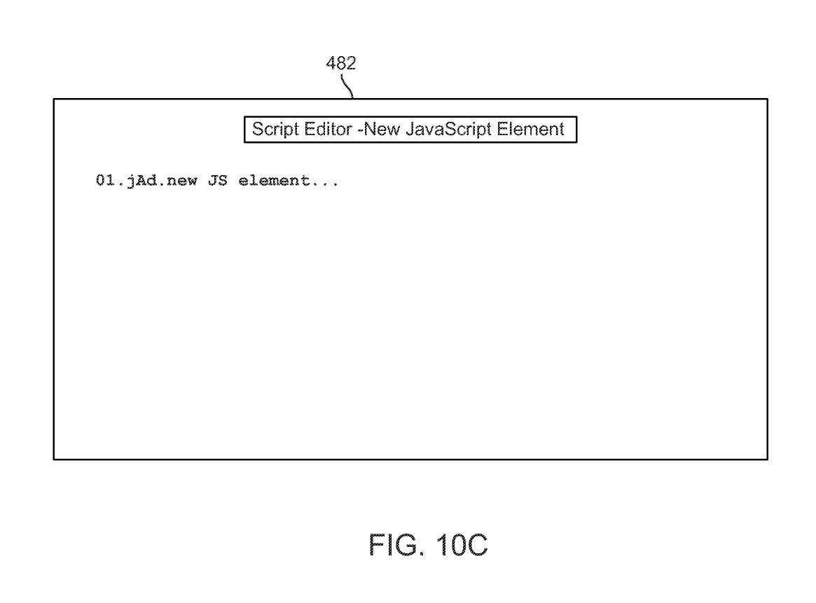

While many adjustments can be made in the form of user-interface elements to allow users with little or no experience working with code to create high quality content, the present technology also facilitates and allows an advanced user to add new elements or customize new elements. FIG. 10A, FIG. 10B, and FIG. 10C illustrate that JavaScript elements can be edited at the code level or created. FIG. 10A shows a JavaScript elements menu having buttons for editing selected code 472 or for creating a custom JavaScript element. FIG. 10B illustrates editing the Carousel JavaScript element 480.

FIG. 10C illustrates adding a new JavaScript element 482. When a new JavaScript element is introduced, the user can also define which elements of the JavaScript element should be interactive or modifiable using an inspector. The user can create a definitions or properties file to accompany the new JavaScript element that defines variable elements within the JavaScript code and a range of available parameters. The properties file can also define which inspector elements need to be provided, e.g., a slider, pull down menu, buttons, etc.

When a content-creator modifies a JavaScript element or adds a new JavaScript element that element can be saved for later use in other projects. Accordingly, a content-creator can make highly customized content and reuse design elements in later projects as they see fit.

In such instances, wherein a content developer adjusts or creates his/her own code, the present technology can also include a debugger application to ensure that the code is operational.

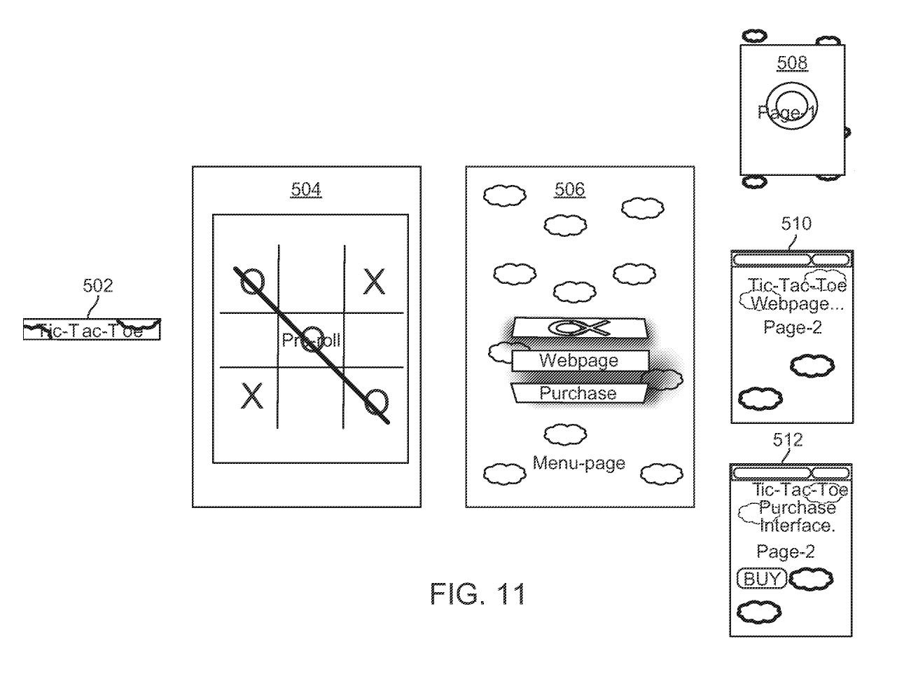

FIG. 11 illustrates a completed application in the graphical site map view. The banner image 502 is illustrated having the clouds background and the Tic-Tac-Toe title of the application. If a user clicks on or interacts with the banner the application will launch and proceed to the Pre-roll page 504. The Pre-roll page 504 is illustrated without the clouds background and containing the Tic-Tac-Toe movie. Presently, the poster frame image is displayed, though, if a user interacts with the image, or a determined period of time has lapsed (such as the time to load or buffer the movie) the movie will begin to play. After the completion of the movie, the application progresses to the Menu-page 506. The Menu-page 506 includes the rotatable 3-D Carousel having links to the images Page-1 508, a Webpage, Page-2 510, and a Purchase Interface, Page-3 512. Clicking on any menu link will take the user to the respective page to view the associated content. Scrolling the rotatable 3-D Carousel will rotate the carousel to the next menu item.

Having a complete application is only one step in successfully publishing electronic content and presenting it to users. As addressed above, today's devices come in many different sizes and have different display and processing capabilities. Accordingly, content often needs to be configured or optimized for different devices. Such a step requires knowledge of the capabilities of each device. Additionally, different users connect to the Internet in various ways and sometimes multiple ways, even in the same usage session. Accordingly, getting content to users requires taking into account the variance in the different network technologies too.

Even if a content developer did understand the varying capabilities of the different device and network connections and further knew the different specifications required to optimize content for delivery and presentation on a content consumer's device, creating optimized packages of each application would be a time consuming process.

Accordingly, the present technology can automatically perform this function. Before creating a content package optimized for a particular device, the assets within the application must have their compatibility with a device's specifications and common network types validated. The content distribution server might also impose certain requirements, and these too can be considered in the validation process.

While some validation can be conducted during the creation of the application (the validation widget in FIGS. 4 and 5 can alert the user that assets having different characteristics are needed) a validation process can also be included to ensure the application is ready to be packaged for distribution.

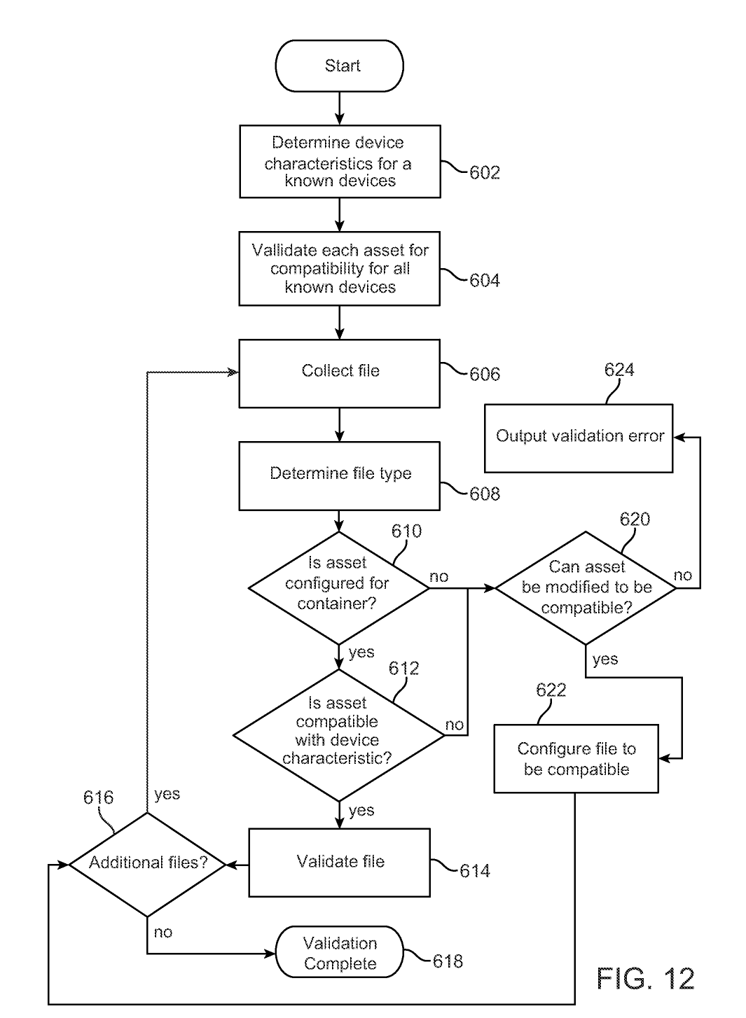

FIG. 12 illustrates an exemplary asset validation process. The authoring tool can be endowed with knowledge of all known devices, groups of devices, connection types, and content distribution servers for which the content might be distributed. Alternatively, the user can input the device characteristics. The authoring tool may also learn of additional device configurations through communication with a server. Regardless of how learned, the authoring tool can determine device characteristics for all known devices and potential connection types 602. In some embodiments the user might select a subset of the known devices and connection types if the content is not intended for distribution outside of those devices.

Based on the determined characteristics of the known devices and connection types, each asset within the content is validated 604 for meeting the relevant characteristics. For example, images might need to be validated for appropriate bpp, and aspect ratio, while videos might require need to be validated for frame rates, size, aspect ratios, compression, encoding type, etc. The validation can occur as follows: A first asset is collected from the finished application 606 and the validation module determines the type of file 608 (image, banner, text, video, etc.).

Based on the asset characteristics the validation module can determine firstly if the asset is appropriate for its use in the application. As addressed above, certain assets are not universally appropriate for all screens in the application. If an incorrectly configured asset was inserted in a container such is determined at 610. An incorrectly configured asset can be one that is not in the appropriate aspect ratio for the frame or one that is not available in the multiple configurations for which the object is expected to be required when viewed by users on their devices. For example, an asset in the banner page might be required to be provided in a landscape and a portrait configuration.

If the validation routine determines that the asset is configured for its container the validation algorithm next determines 612 if the asset is compatible with the characteristics of each device on which it might be displayed. For example, the routine determines if the asset is available in all aspect ratios and pixel densities and file sizes that might be required to serve and display the content on the devices.

If the validation routine determines the asset is compatible with each device, the asset validation is complete 614 and the routine determines if there are additional assets requiring validation 616. If not the validation routine is complete and it terminates 618.

If, however, there are additional files to validate, the routine begins anew collecting the next asset 606.

Returning to 610 wherein the asset is analyzed for configuration with its container and 612 wherein the asset is analyzed for configuration with device characteristics, if either analysis determines that the asset is not properly configured for the container or device characteristics, respectively, the routine proceeds to determine if the asset can be modified automatically at 620. Assets can be modified automatically where it might require resizing, encoding, or generation of a lower quality asset. If the asset can be modified to be compatible then the routine proceeds to 622 and the asset is appropriately configured. In some embodiments the user is given the option of whether the routine should perform the modification. If the asset is not determined to be modifiable at 620, the routine outputs a validation error and requests user involvement to fix the problem 624.

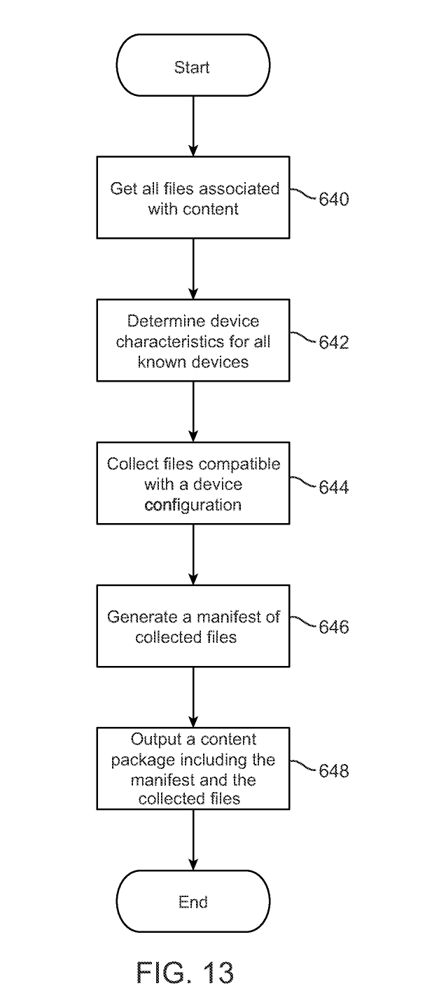

Once all assets have been verified the application must be packaged for upload and use by a content delivery server. FIG. 13 illustrates an exemplary method of packing the application for upload to the content delivery server. At 640 the routine gathers all assets associated with the application. At 642 the routine determines device configurations and collects the assets that are compatible with one of the device configurations 644 and generates a manifest of collected files 646. The manifest is a descriptive file identifying each of the assets and their relationship to the main application file. Finally, a content package is output including all assets and the manifest configured for the specified device configuration 648.

The routine illustrated in FIG. 13 can be repeated for each device configuration desired. Alternative, the manifest file can designate different assets for different device configurations. Regardless of the method of creating the package for upload to the server, the output should be according to the server's requirements. If the server is configured to accept one application configured for each device than the method of FIG. 13 is followed. If the server is configured to accept a manifest describing all assets and the appropriate situation for employing the assets then such a package can be created.

Before the package can be uploaded to a content delivery server, the application must first be tested. This step can be especially important for professional content creators. Since content creation is their livelihood they need to view each screen of the application as it will be displayed on the individual devices. The importance of this step is even more important when some assets have been modified by the authoring tool and therefore may not have been viewed by the content creator.

The application can be tested in each format (device configuration) for which it is expected to run. Only after the application has been tested for a given device configuration should it be approved to be uploaded to the server for distribution to content consumers.

In some embodiments, the above-described technology is an HTML5 authoring tool which is useful for, among other things, creating mobile advertisements. It embodies a number of key processes for authoring, testing and publishing advertisements to the mobile advertisement network. However, many of the activities described herein are applicable to HTML5 authoring in general.

In one aspect, the present technology is used for authoring of interactive HTML5 content for the web, for advertising, for inclusion in non-web content delivery applications such as, a book reader, a magazine, an interactive menu system for accessing video content whether viewed on a traditional computer, mobile devices, tablets, set-top boxes, or other devices.

The first step in creating an advertisement is defining the structure and flow of an ad. This can be defined manually, by adding and ordering pages using a graphical site map, or automatically, by selecting a pre-built project template. The project template defines the initial structure of the ad, for example: a banner page, leading to a splash page that cycles while content is loaded, leading to a “pre-roll” video page that plays an introductory video, leading to a menu page with navigation options to one or more content pages displaying company, product, or other information the advertiser wishes to provide. Project templates may define a rigid set of possible pages that cannot be edited, or may define a starting set of pages that the user can modify by adding, removing, reordering, or restructuring the flow of pages, or may be based on various factors including lines of business (automotive, publishing, music, film, consumer electronics, fashion/apparel, etc).

The next step is defining the types of pages to be included in the project. The project templates may define the types of pages to be used or they can define the category of each page and allow the user to select from a range of page templates in that category. For example the project template can define that one of the pages is intended to be a “menu.” The user can select from a range of possible menu “page templates” to apply.

Once a page template has been applied (either as determined by the project template or manually selected by the user), page-specific attributes can be edited, for example: the background color of the page, the size of the page, the orientation of the page, other page template specific properties, number of elements in a gallery, the default location for a map, and so on.

The next step in the process is adding content to the pages in the project. The page templates contain placeholder elements for content to be provided by the advertiser, for example, an image placeholder to be filled in with a company logo or product image. Placeholder elements may have pre-determined styles applied to them, for example, a button with a preset color, border, opacity, etc. In such a case, the user need only provide text for the title of the button. In some aspects, the styles may be rigid and non-modifiable by the user, while in other aspects, the styles may be set initially but editable by the user by editing individual parameters, e.g., background color, border color, etc. In some embodiments, the styles are edited visually using an inspector rather than by specifying the CSS attribute and value, thus eliminating the need for in-depth knowledge of CSS properties. The styles can also be edited by applying a style preset representing a number of style elements and their associated value, e.g., “red flame” style with red gradient background, bright orange border, and yellow glow shadow.

In some instances, placeholder elements can be “pre-rigged” with animations that persist after an element has been customized by the user. For example, an image element set to fade in when it is first displayed. Some elements can represent multiple content items in a list, grid, or other “gallery” or “container” style display, such as e.g., a “carousel” of videos, a sliding gallery of images, a scrolling view of a very large image or set of images, etc. Some elements can represent multiple “cells” in a list, grid, or other “gallery” or “container” style display, with multiple content elements within each “cell”, e.g., a “carousel” containing a video, title, and short description, a sliding gallery of movie character images with audio buttons that plays a voice clip from the character, etc.

Content can be added to a project in a variety of ways. For example, text content can be modified by typing new values into the item, or by typing into a text field in its inspector. Content can be can be dragged and dropped onto a placeholder, even a placeholder containing other content.

The application also supports the creation of content for devices with different hardware characteristics such as display size, resolution and/or device orientation. Page templates and page elements can automatically select the appropriate content for the target environment (device hardware). For example, page templates are provided for specific device resolutions, page templates are provided for specific device orientations (e.g. portrait and landscape), and page templates can handle changes in a device orientation and reconfigure their elements as changes occur. Page templates may be limited to a single display resolution, relying on hardware scaling of the video output by the device or they can handle changes in display resolution and reconfigure their elements as change occur. For example, the templates can animate elements to new sizes/positions as resolution changes, scale bitmap objects to fit the new resolution, substitute bitmap assets with new assets appropriate for the new resolution.

An advertisement can contain multiple “renditions” of content to be automatically selected by at runtime for optimal display, e.g., normal and hi-res versions of bit-map images for display at different scales/display resolutions, multiple bit rate video streams to be selected based on network, device, or other criteria for optimal user experience.

Multiple renditions may be provided to the advertisement manually by the user, or they may be provide automatically by the application by downsampling a “hi-resolution” version to lower resolution versions as needed or by downsampling an ultra- resolution “reference” version to a “hi-resolution” version and all subsequent lower resolution versions as needed. In the case of automatic downsampling, this can be done based on the original asset dimensions assuming it will be displayed at its natural size, e.g., a 100×100 pixel image can be down sampled to a 50×50 image if the hi-resolution and lo-resolution requirements differ by 50% in each dimension.

In addition to dimension-based “renditions”, bandwidth-based “renditions” may also be created, and other advanced optimization techniques can be applied, to ensure optimal download speed over varying network types (EDGE, 3G, WiFi).

To ensure compatibility with the advertisement server, networks and known devices, image assets are analyzed to ensure they meet size requirements such as a maximum total size, and maximum image resolution based on bits-per-pixel (BPP), e.g., EDGE network: <0.75 BPP, 3G network: <1.0 BPP, and WiFi: <2.0 BPP.

Video assets are analyzed to ensure they meet size requirements such as a maximum total size and maximum data rate, e.g., EDGE: 80 kbps, 3G: 300 kbps, and Wi-Fi: 1000 kbps.

System-generated and user-provided text assets are processed. For example, JavaScript is concatenated and minified, CSS is concatenated and minified, HTML, JavaScript and CSS is compressed, etc.

Advanced techniques are applied to image assets: multiple images are combined into a single “sprite” image to speed up downloading (one HTTP request versus multiple); HTML, CSS and JavaScript re edited to refer to the new sprite; individual images are inlined as base 64 data into HTML files to minimize HTTP requests; and a web archive is created as a single initial download (tar/zip) with essential advertisement elements.

The system includes the ability for users to add custom JavaScript code in a variety of ways. Write handlers that implement responses to events generated by the system. Such events can include: 1) a button was pressed; 2) the user touched the screen; 3) a new page was navigated to; and 4) the advertisement application was paused, or resumed. Custom JavaScript code can also be used for implementing custom on-screen controls (buttons, sliders, etc.); implementing custom on-screen display elements (views, graphs, charts); implementing custom logic (calculators, games, etc.); and integrating with WebServices functionality, etc. Any custom elements can also be saved for reuse in other projects.

During development of the HTML 5 application, content and functionality can be verified in an interactive environment by on-screen preview within the authoring environment and by toggling the editing “canvas” from authoring mode to interactive mode causing the on-screen elements to become “live” and respond to user input. The project can also be exported to disk such that it can be opened and viewed by the appropriate client application on the users local machine such as a web browser, other desktop reader application, mobile web browser, or other mobile reader application. Additionally, the project can be exported to a shared network location so it can be opened and viewed by the appropriate client application on a remote, network connected machine. Exporting to a shared network location also allows the project to be opened and viewed by the appropriate client application running in a local simulated environment. Another mechanism of exporting is to publish the content from within the authoring tool that allows access to the content via an appropriate client application running on a mobile device. In some embodiments, live changes ca be made in the authoring environment and are published to the viewing application.

As addressed above, testing and previewing the authored application can be an extremely important step, especially for those that are using the authoring tool professionally. Accordingly the authoring tools testing simulations include the ability to test in many different network states as well so as to simulate the real world operation of the application. In some embodiments, the authoring tool can simulate a fast connection becoming slow so that the content creator can view how the advertisement might look if server decided to send a lower resolution asset based on its real time analysis of network condition.

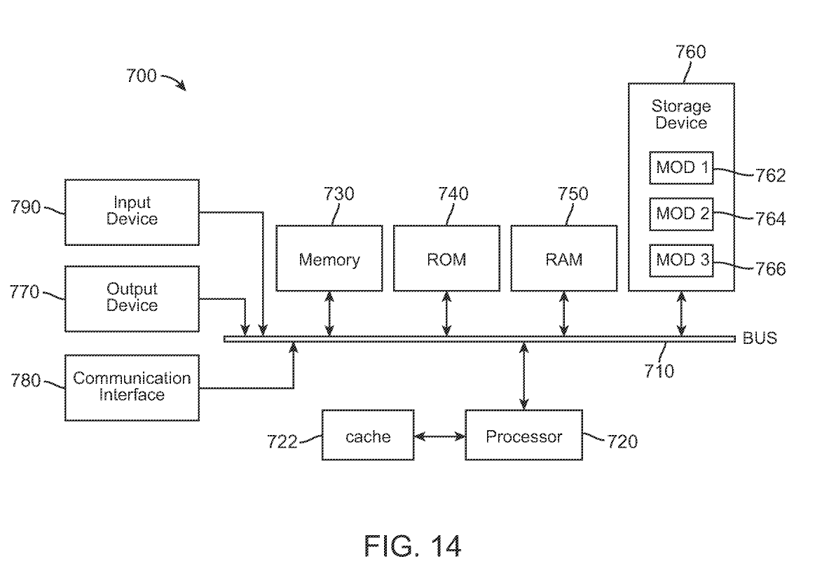

As shown in FIG. 14, an exemplary system 700 for implementation of the present technology includes a general-purpose computing device 700, including a processing unit (CPU or processor) 720 and a system bus 710 that couples various system components including the system memory 730 such as read only memory (ROM) 740 and random access memory (RAM) 750 to the processor 720. The system 700 can include a cache 722 of high speed memory connected directly with, in close proximity to, or integrated as part of the processor 720. The system 700 copies data from the memory 730 and/or the storage device 760 to the cache 722 for quick access by the processor 720. In this way, the cache 722 provides a performance boost that avoids processor 720 delays while waiting for data. These and other modules can be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer readable storage media provide nonvolatile storage of computer readable instructions, data structures, program modules and other data for the computing device 700. In one aspect, a hardware module that performs a particular function includes the software component stored in a non-transitory computer-readable medium in connection with the necessary hardware components, such as the processor 720, bus 710, display 770, and so forth, to carry out the function. The basic components are known to those of skill in the art and appropriate variations are contemplated depending on the type of device, such as whether the device 700 is a small, handheld computing device, a desktop computer, or a computer server.

Although the exemplary embodiment described herein employs the hard disk 760, it should be appreciated by those skilled in the art that other types of computer readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example the functions of one or more processors presented in FIG. 14 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations discussed below, and random access memory (RAM) 750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 14 can practice all or part of the recited methods, can be a part of the recited systems, and/or can operate according to instructions in the recited non-transitory computer-readable storage media. Such logical operations can be implemented as modules configured to control the processor 720 to perform particular functions according to the programming of the module. For example, FIG. 14 illustrates three modules Mod1 762, Mod2 764 and Mod3 766 which are modules controlling the processor 720 to perform particular steps or a series of steps. These modules may be stored on the storage device 760 and loaded into RAM 750 or memory 730 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer-implemented method comprising:
receiving a collection of assets and other files collectively being deliverable content;
determining device criteria associated with one or more devices which are intended to receive the deliverable content; and
validating the deliverable content for each of the one or more device which are intended to receive the deliverable content.

2. The computer-implemented method of claim 1, further comprising optimizing the deliverable content for one of the devices which are intended to receive the deliverable content.

3. The computer-implemented method of claim 1, wherein the validating includes analyzing an image asset to determine if it meets a size criteria associated with one of the devices which are intended to receive the deliverable content.

4. The computer-implemented method of claim 1, wherein the validating includes analyzing a video asset to determine if it meets an encoding criteria associated with one of the devices which are intended to receive the deliverable content.

5. The computer-implemented method of claim 1, wherein the validation includes analyzing the deliverable content to determine if an appropriate version of an asset exists for each of the one or more devices which are intended to receive the deliverable content.

6. The computer-implemented method of claim 1, further comprising:
packaging the validated deliverable content into an archive.

7. The computer-implemented method of claim 1, further comprising:
providing an authoring tool for creating the deliverable content.

8. The computer-implemented method of claim 2, wherein the optimizing includes compressing program code.

9. The computer-implemented method of claim 2, wherein the optimizing includes selecting assets from among two or more assets of varying quality based on the network connection used by the device.

10. A computer-implemented method comprising:
receiving a collection of assets and other files collectively being deliverable content; and
determining device criteria associated with one or more devices which are intended to receive the deliverable content; and
compiling at least a portion of the collection assets and other files into a content package based on device model criteria.

11. The computer-implemented method of claim 10, wherein at least two different content packages are compiled, each content package being optimized for a different device model based on associated device criteria.

12. The computer-implemented method of claim 10, wherein the device criteria describes hardware capabilities of the device models.

13. The computer-implemented method of claim 10, wherein the device criteria describes a general capability shared by one or more of the devices.

14. The computer-implemented method of claim 10, further comprising:
validating the deliverable content for the device model which is intended to receive the deliverable content.

15. A non-transitory computer-readable medium having computer-readable code stored thereon for causing a computer to execute a method comprising:
receiving a collection of assets and other files collectively being deliverable content;
determining device model criteria associated with one or more device models which are intended to receive the deliverable content; and
validating the deliverable content for each of the one or more device which are intended to receive the deliverable content.

16. The non-transitory computer-readable medium of claim 15, further having computer-readable code stored thereon for causing a computer to execute the method further comprising
compiling at least a portion of the collection assets and other files into a content package based on device model criteria.

17. The non-transitory computer-readable medium of claim 15, wherein at least two different content packages are compiled, each content package being optimized for a different one of the one or more device models based on the associated device criteria.

18. The non-transitory computer-readable medium of claim 15, wherein the device criteria describes hardware capabilities of the device models.

19. The non-transitory computer-readable medium of claim 15, further having computer-readable code stored thereon for causing a computer to execute the method further comprising
generating a plurality of delivery options for any asset, and
designating the delivery options as respectively appropriate for delivery when the asset is to be delivered to a device associated with specified network connectivity characteristics.

20. The non-transitory computer-readable medium of claim 19, wherein the device is determined to be associated with the specified network connectivity characteristic at run time.

21. A system comprising:
a computer configured to execute a digital content authoring tool for a collection of assets and other files collectively being deliverable content and validating the assets as being compatible with different device criteria associated with two or more devices; and
a content delivery server configured to select an asset from the collection of assets that is compatible with the criteria associated with a device that is requesting the deliverable content and to deliver the deliverable content to one of the devices over a network.

22. The system of claim 21, wherein the content delivery server is further configured to select an asset from the collection of assists that is additionally compatible with a network condition characteristic associated with the requesting device.

23. The system of claim 21, where the validated asset is an asset having two or more versions, each version being compatible with the different device criteria, the collective set of versions of the asset being compatible with each different device criteria.

24. The system of claim 21, wherein the server is configured to select the asset version that is compatible with a device criterion associated with the requesting device.
